(19) United States
(12) Patent Application Publication
(10) Pub. No.: US 2017/0103414 A1
(43) Pub. Date: Apr. 13, 2017

(54) REPRESENTING A METRIC FOR MARKETING CHANNELS

(71) Applicant: HEWLETT PACKARD ENTERPRISE DEVELOPMENT LP, Houston, TX (US)

(72) Inventors: Yong LIU, Palo Alto, CA (US); Jorge LAGUNA, Palo Alto, CA (US); Kevin Dean BOLDEN, Palo Alto, CA (US); Matthew J. WRIGHT, Orem, UT (US)

(73) Assignee: HEWLETT PACKARD ENTERPRISE DEVELOPMENT LP, Houston, TX (US)

(21) Appl. No.: 15/306,301

(22) PCT Filed: Jun. 27, 2014
(86) PCT No.: PCT/US2014/044495

§ 371 Date: Oct. 24, 2016

(51) Int. Cl. G06Q 30/02

(52) U.S. Cl. CPC G06Q 30/0249

(57) ABSTRACT

Values of a target metric, and amounts spent on respective different types of channels for marketing an offering, are received. A first representation provides a response of the target metric to an amount spent on a marketing campaign of each of the different types of channels. A second representation provides a response of the target metric to time elapsed since the marketing campaign of each of the different types of channels. Models of the target metric for the corresponding different types of channels are determined using the first representations and the second representations.

### BACKGROUND

A variety of different marketing channels can be used for marketing an offering, such as a product and/or service. Examples of marketing channels include traditional marketing channels such as television, radio, and print media, and electronic marketing channels such as online media including search engine marketing, displayed advertising, email and so forth. An entity can select which of the marketing channels to use to market the entity's offering.

### BRIEF DESCRIPTION OF THE DRAWINGS

Some implementations are described with respect to the following figures.

FIG. 1 is a flow diagram of an example process according to some implementations.

FIG. 2 is a graph depicting various example time responses of a target metric, which are usable to develop models of the target metric according to some implementations.

FIG. 3 is a graph depicting various example responses of the target metric to amounts spent on respective marketing channels, which are usable to develop models of the target metric according to some implementations.

FIG. 4 is a flow diagram of an example process according to further implementations.

FIG. 5 is a block diagram of an example computer system that incorporates some implementations.

### DETAILED DESCRIPTION

An entity can choose which of a variety of marketing channels to use for marketing an offering and/or service of the entity. As examples, the entity can be an individual, a business concern, a government agency, an education organization, and so forth. Examples of marketing channels that can be used to market an offering include television, radio, direct mail, print media (e.g. a magazine, a newspaper, etc.), a billboard, electronic mail, online media (e.g. websites, social media sites, search results, display ads, and so forth), or any other medium through which an entity can present information for the purpose of marketing an offering. The information that is presented to market an offering can include an advertisement, a promotion, a rebate, and so forth.

For increased effectiveness, the entity may run multiple marketing campaigns concurrently on multiple marketing channels. A “marketing campaign” can refer to any effort or activity of an entity in presenting information to market an offering. However, the entity may have a marketing spend budget that sets a cap on the amount that the entity can spend on marketing.

An issue faced by the entity is the determination of how to allocate the marketing budget across multiple marketing channels. The entity may perform the allocation of the marketing budget among the marketing channels to achieve one or multiple goals, such as to increase (e.g. maximize) a business target metric such as revenue, return on investment, growth rate, market share, lead generation, user engagement for branding, or any other type of goal.

Allocating a marketing budget among multiple different types of marketing channels can use media mix modeling (also referred to as marketing mix modeling), which allows for analysis to determine the impact of marketing tactics on a target metric. An issue with some example media mix modeling techniques is that they may not properly account for delayed time responses of consumers to marketing campaigns. The lag effect of marketing on consumer behavior can be referred to as advertising adstock or carry-over effect (more generally referred to as a time response effect). If the time response effect is not properly considered, then the media mix modeling may not produce accurate results.

In accordance with some implementations, multiple effects of marketing campaigns can be considered in media mix modeling. The multiple effects include a time response effect (where a time response is a response of a target metric to time elapsed since a marketing campaign of a particular marketing channel), and a spend response effect (where a spend response is a response of the target metric to the amount spent on a particular marketing channel). In further examples, the multiple effects can include other effects.

In the ensuing discussion, reference is made to revenue as being the target metric. Thus, for example, media mix modeling can seek to allocate a marketing budget among different types of marketing channels to increase (e.g. maximize) revenue. In other examples, similar techniques are applicable for other types of target metrics, such as profit, sales, growth rate, return on investment, market share, lead generation, and so forth. Note that a combination of target metrics may be considered.

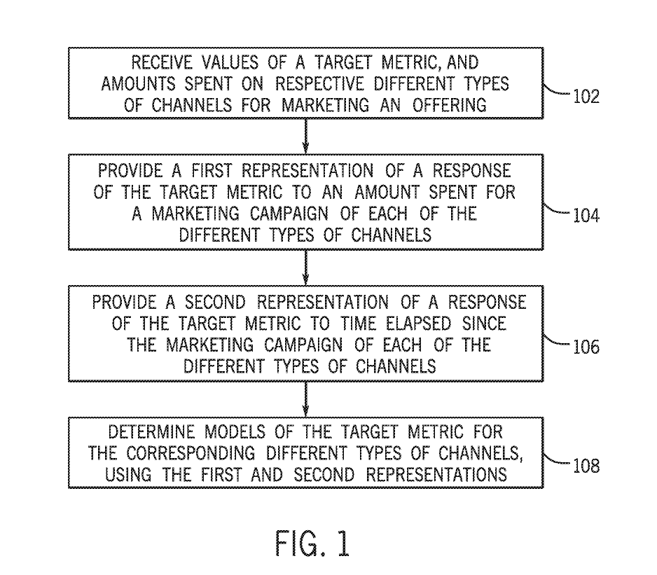

FIG. 1 is a flow diagram of a process according to some implementations. The process of FIG. 1 can be performed by a system, which can include a computer, multiple computers, or any other arrangement that includes one or multiple processors. The process receives (at 102) values of a target metric, and amounts spent on respective different types of channels for marketing an offering. The received values of the target metric and the received amounts spent on respective marketing channels can be part of collected historical data.

Note that reference to a target metric can be a reference to a single target metric or multiple target metrics, and that reference to an offering can be a reference to a single offering or multiple offerings.

The process also provides (at 104) a first representation of a response of the target metric to the amount spent for a marketing campaign of each of the different types of channels. Multiple first representations are provided for respective different types of channels.

The process further provides (at 106) a second representation of a response of the target metric to time elapsed since the marketing campaign of each of the different types of channels. Multiple second representations are received for respective different types of channels. The first and second representations are based on the received values of the target metric and the received amounts spent. The elapsed time can be measured from an end of a marketing campaign, a start of a marketing campaign, or at some other part of a marketing campaign.

The process determines (at 108) models of the target metric for the corresponding different types of channels, using the first representations and the second representations.

Time Response

The following provides an explanation of the time response effect according to some examples. In response to marketing, the returned revenue is typically not expected at any one time point. Rather, the returned revenue is expected to be distributed over time, since the responses of individual consumers to a marketing campaign may vary. Some consumers may act more quickly since such consumers may be ready to buy, while other consumers may wait before acting. The effect of a marketing campaign can last for some amount of time after the marketing campaign ends.

A time response representation can be provided to represent the time response effect. The time response representation is an example of the first representation provided at task 104 in FIG. 1. The time response representation can include one or some combination of the following effects: time latency, time smear, and time decay. Time latency refers to an elapsed time from the start of a marketing campaign to the first purchase resulting from the marketing campaign. Time smear refers to a spread of purchases over time in response to the marketing campaign. Time decay refers to the length of time of the effectiveness of a marketing campaign after the marketing campaign ends, where the effect of the marketing campaign on purchasing behavior is expected to decay with increase in time from the end of the marketing campaign.

In some examples, a Gaussian convoluted exponential decay formulation (or more generally, a Gaussian function) can be used as the time response representation. In other examples, other types of time response representations can be employed. An example of a Gaussian convoluted exponential decay formulation is set forth below:

$$\begin{matrix}f ( t ; u , σ , τ ) = \frac{1}{2 τ} {e}^{\frac{1}{2 τ} ( 2 μ + \frac{{σ}^{2}}{τ} - 2 t )} erfc ( \frac{μ + \frac{{σ}^{2}}{τ} - t}{\sqrt{2} σ} ) , \\ where & ( Eq . 1 ) \\ erfc ( x ) = 1 - erf ( x ) = \frac{2}{\sqrt{π}} {\int }_{x}^{∞} {e}^{- {u}^{2}} d u . & ( Eq . 2 )\end{matrix}$$

In Eq. 1, μ is Gaussian mean, which characterizes time latency; σ is the Gaussian width, which quantifies time smear or how soon a marketing campaign effect reaches a maximum; and τ is the decay life time, which indicates how quickly a marketing campaign effect diminishes.

In Eq. 1, t represents time, and x is expressed as

$$\frac{μ + \frac{{σ}^{2}}{τ} - t}{\sqrt{2} σ} .$$

In Eq. 2, u is an integral variable, and goes from x to infinity.

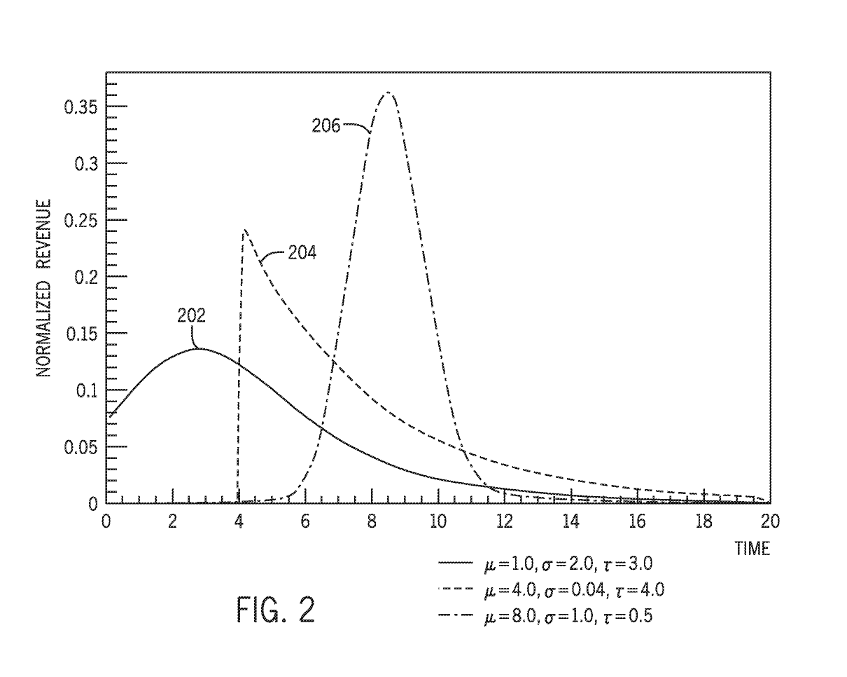

FIG. 2 is a graph that includes curves 202, 204, and 206, representing f(t; μ, σ, τ) (the Gaussian convoluted exponential decay) for respective different example parameter configurations (different combinations of values of μ, σ, and τ). The graph of FIG. 2 plots a curve with respect to time (horizontal axis) and revenue (vertical axis). Note that the revenue on the vertical axis in the graph of FIG. 2 is a normalized revenue, which has been normalized so that the area under each curve is equal to 1. In other examples, the revenue on the vertical axis is not normalized.

A curve in the graph of FIG. 2 can be shifted left or right along the time axis (without shape change) by varying μ. Increasing the value of μ shifts a curve to the right on the time axis (indicating increase time latency). Reducing the value of σ reduces the Gaussian width. Increasing the value of τ increases the amount of time decay from the end of a marketing campaign.

In accordance with some implementations, the time response representation, such as according to Eq. 1 above, can be determined based on received input data, including values of the revenue received in multiple time intervals (e.g. daily revenue, weekly revenue, monthly revenue, etc.), and amounts spent on respective different types of marketing channels in the corresponding time intervals. The determination of the time response representation is based on solving for the parameters, μ, σ, and τ, as discussed further below.

Spend Response

In some examples, the response of the revenue to spend can be non-linearly monotonically increasing, and can become saturated at some point (saturation occurs when increased spending does not lead to increased revenue). The point of saturation is the point at which the maximal revenue return has been reached. Note that the revenue response to spend may be different for different marketing channels. Some marketing channels may be more sensitive to small spend, while other marketing channels may be more sensitive to large spend.

In some examples, the spend response representation can include a normalized lower incomplete Gamma function (which is an example of the second representation provided at task 106 in FIG. 1), as set forth below:

$$\begin{matrix}Gamma ( x ; k , θ ) = \frac{γ ( k , \frac{x}{θ} )}{Γ ( k )} , \\ where & ( Eq . 3 ) \\ γ ( s , x ) = {\int }_{0}^{x} {t}^{s - 1} {e}^{- t} d t , & ( Eq . 4 )\end{matrix}$$

and where k is a shape parameter and θ is a scale parameter.

In other examples, other spend response representations can be employed.

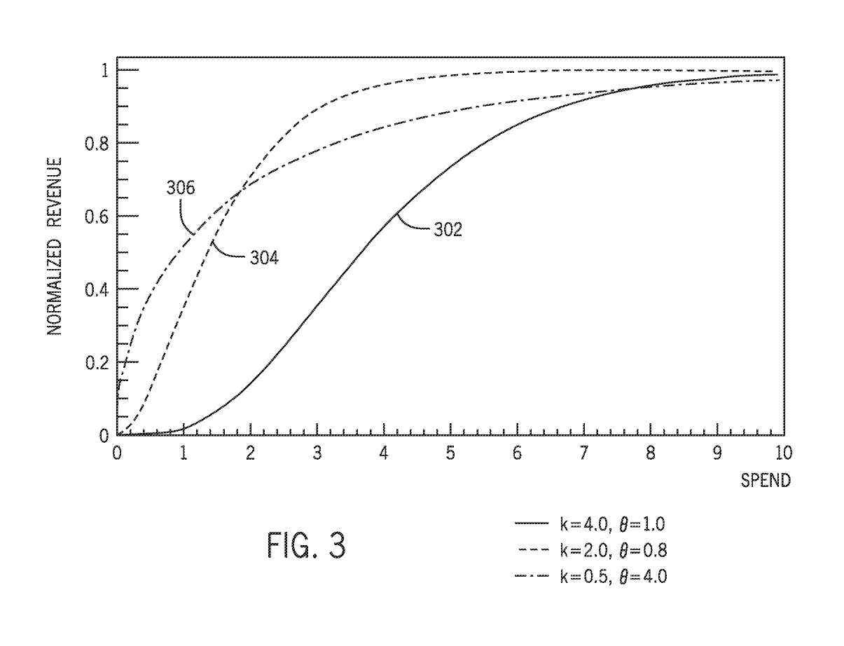

FIG. 3 is a graph that plots curves 302, 304, and 306 with respect to spend (horizontal axis) and normalized revenue (vertical axis). The different curves 302, 304, 306 represent the Gamma function of Eq. 3 for different combinations of k and θ values. The curve 302 represents a response of revenue to spend that is more sensitive to large spend. The curve 306 represents a response of revenue to spend that is more sensitive to small spend. The curve 304 represents an intermediate response to spend.

The spend response representation, which can be characterized by any of the example curves 302, 304, and 306, for example, can be derived from received input data, such as revenue values and amounts spent on marketing channels. The determination of the spend response representation is based on solving for the parameters, k, θ, as discussed further below.

Determining Response Models of Marketing Channels

In accordance with some implementations, given historical input data that includes revenue and spend for each marketing channel, the time response representation and the spend response representation are derived by solving for parameters of the time response representation and spend response representation for each marketing channel. Once the time response representation and the spend response representation are derived, a spend response model (which models revenue as a function of spend) can be determined for each marketing channel. The spend response model is an example of the model determined at task 108 in FIG. 1. From the spend response models created for the respective marketing channels, a determination can be made regarding how to allocate a marketing budget across the different types of marketing channels to increase total revenue (e.g. maximized total revenue).

In some examples, it can be assumed that just revenue data and channel spend data over time are available, and that certain other input data may not be available. For example, information regarding transactions and information about specific users or consumers may not be available, which can make the determination of the time response representations for the different types of marketing channels more challenging. If just revenue and channel spend data over time is available, then a channel response model for each marketing channel can be derived using a minimization procedure, using the time response representation and the spend response discussed above.

The channel response can be expressed as revenue received in time interval i, where revenue received in time interval i is represented as rᵢ:

rᵢ=Σⱼ₌₁^{M}∫_{t=-∞}^{t=i}R_{j max}×Gamma(s(t); kⱼ, θⱼ)×f(t; μⱼ, σⱼ, τⱼ) dt, (Eq. 5)

where i is data point index or time index (i=1 to N, and N>1), j identifies a specific marketing channel (j=1 to M, M>1), and s(t) is the amount of spend of a marketing campaign in a marketing channel j that is function of time t. In some examples, R_{j max} represents a maximal absolute amount of revenue response to an infinitely large spend, for channel j. In Eq. 5, revenue values rᵢ in respective time intervals i and spend amounts s(t) for each respective channel in respective time intervals i are part of input data. If the input data is discretized, the time integral in Eq. 5 can be replaced by summation (or other aggregation) over some number of time intervals prior to and including the time interval that revenue data point rᵢ corresponds to.

The model parameters can be determined by solving the function:

$${arg}_{{R}_{jmax} , {k}_{j} , {θ}_{j} , {μ}_{j} , {σ}_{j} , {τ}_{j}} min {\sum }_{i = 1}^{N} {( \begin{matrix}{r}_{i} - {\sum }_{j = 1}^{M} {\int }_{t = - ∞}^{t = i} {R}_{jmax} \times \\ Gamma ( s ( t ) ; {k}_{j} , {θ}_{j} ) \times f ( t ; {μ}_{j} , {σ}_{j} , {τ}_{j} ) d t\end{matrix} )}^{2} . \qquad ( Eq . 6 )$$

Eq. 6 seeks to find the values of R_{j max}, kⱼ, θⱼ, μⱼ, σⱼ, τⱼ for which the function

$${\sum }_{i = 1}^{N} {( {r}_{i} - {\sum }_{j = 1}^{M} {\int }_{t = - ∞}^{t = i} {R}_{jmax} \times Gamma ( s ( t ) ; {k}_{j} , {θ}_{j} ) \times f ( t ; {μ}_{j} , {σ}_{j} , {τ}_{j} ) d t )}^{2}$$

is a minimum value.

In Eq. 6, six unknown parameters for each marketing channel j are to be determined. These six unknown parameters are kⱼ, θⱼ, μⱼ, σⱼ, τⱼ, and R_{j max}. Once the foregoing parameters are determined, the time response model and the spend response model for each marketing channel is derived. Note that solving for the unknown parameters considers both the time response representations and the spend response representations simultaneously, as expressed in Eq. 6.

In some examples, a Monte Carlo technique can be applied to solve for the unknown model parameters for each marketing channel j. The Monte Carlo tries all possible values of kⱼ, θⱼ, μⱼ, σⱼ, τⱼ, and R_{j max} in meaningful ranges.

For each set of model parameter values tried by the Monte Carlo technique, the value of the sum

$${\sum }_{i = 1}^{N} {( {r}_{i} - {\sum }_{j = 1}^{M} {\int }_{t = - ∞}^{t = i} {R}_{jmax} \times Gamma ( s ( t ) ; {k}_{j} , {θ}_{j} ) \times f ( t ; {μ}_{j} , {σ}_{j} , {τ}_{j} ) d t )}^{2}$$

is recorded. If the value of the sum for a currently considered set of model parameter values is less than a value of the sum for another set of the model parameter values previously tried, then the currently set of model parameter values is kept. The process continues until the set of model parameter values associated with the minimum of the sum is identified.

An example of a Monte Carlo technique that can be employed is a Markov Chain Monte Carlo optimization technique.

In other examples, a numeric optimization tool such as a TMinuit minimization package can be employed. In further examples, other techniques of solving for the unknown model parameters can be employed.

Allocating Marketing Budget Across Marketing Channels

Once the spend response representation, expressed as Gamma(s; kⱼ, θⱼ) in some examples, is derived as discussed above, the spend response model (model of revenue based on spend) for each marketing channel can be expressed as:

rⱼ(sⱼ)=R_{j max}×Gamma(sⱼ; kⱼ, θⱼ). (Eq. 7)

In Eq. 7, sⱼ represents the spend to be allocated into channel j. Once the spend response model, rⱼ(sⱼ), is derived, the marketing budget allocation can be determined by performing the following optimization:

$${arg}_{{s}_{j} j = 1 , 2 , … , M} max {\sum }_{j = 1}^{M} {r}_{j} ( {s}_{j} ) . \qquad ( Eq . 8 )$$

Eq. 8 seeks to find the value of sⱼ for each channel j that maximizes

$${\sum }_{j = 1}^{M} {r}_{j} ( {s}_{j} ) .$$

Solving for sⱼ in Eq. 8 can be performed by using a Monte Carlo technique, a numeric optimization technique as implemented in TMinuit, or some other technique.

In some examples, the determination of sⱼ for each channel j (by solving Eq. 8) can be performed on a periodic or other repeated basis. For example, the determination of sⱼ for each channel j can be performed once each time interval i.

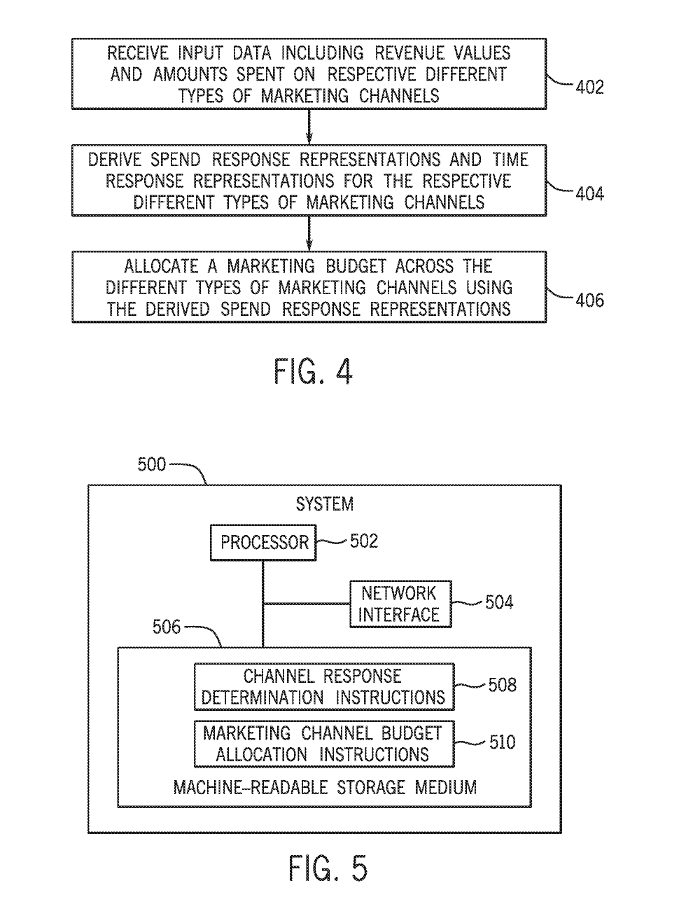

FIG. 4 is a flow diagram of a process according to further implementations. The process of FIG. 4 can be performed by a system. The process receives (at 402) input data including revenue values and amounts spent on respective different types of marketing channels.

The process derives (at 404) spend response representations and time response representations for the respective different types of marketing channels, each of the spend response representations specifying a response of revenue to an amount spent on a respective one of the different types of marketing channels, and each of the time response representations specifying a time response to a marketing campaign of a respective one of the different types of marketing channels. Deriving the spend response representations and the time response representations is based on solving for parameters of the spend response representations and the time response representations using the input data.

The process allocates (at 406) a marketing budget across the different types of marketing channels using the derived spend response representations.

The foregoing techniques can be applied to budget allocation processes at any of various levels. For example, a budget allocation process can be performed for a business unit of a company, for a geographic region, for a product category, for a particular retail store, and so forth.

System Architecture

FIG. 5 is a block diagram of an example system 500, which includes one or multiple processors 502. A “system” as used herein can refer to a computer, multiple computers, a processor, multiple processors, or any other electronic device (or multiple electronic devices).

The processor(s) 502 can be coupled to a network interface 504 (for communications over a network) and a non-transitory machine-readable storage medium (or storage media) 506.

The storage medium (or storage media) 506 can store channel response determination instructions 506 for determining models of a target metric for respective marketing channels, and marketing channel budget allocation instructions 510 for allocating a marketing budget across the marketing channels, based on the determined models. The instructions 506 and/or 510 can perform various tasks discussed above, such as those depicted in FIGS. 1 and 4.

The machine-readable instructions 508 and 510 are loaded for execution on the processor(s) 502. A processor can include a microprocessor, microcontroller, processor module or subsystem, programmable integrated circuit, programmable gate array, or another control or computing device.

The storage medium (or storage media) 506 can include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
receiving, by a system including a processor, values of a target metric, and amounts spent on respective different types of channels for marketing an offering;
providing, by the system, a first representation of a response of the target metric to an amount spent on a marketing campaign of each of the different types of channels;
providing, by the system, a second representation of a response of the target metric to time elapsed since the marketing campaign of each of the different types of channels, the first representation and the second representation based on the received values of the target metric and the received amounts spent; and
determining, by the system, models of the target metric for the corresponding different types of channels, using the first representations and the second representations.

2. The method of claim 1, further comprising:
allocating, by the system, a spend budget among the different types of channels, based on the models of the target metric.

3. The method of claim 1, wherein receiving the values of the target metric comprises receiving the values of the target metric in corresponding time intervals, wherein receiving the amounts spent on the respective different types of channels for presenting media comprises receiving the amounts spent in the corresponding time intervals, and wherein determining the models of the target metric is based on aggregating over the time intervals.

4. The method of claim 1, wherein providing the first representation of the response of the target metric to the amount spent on the marketing campaign of a first of the different types of channels comprises providing the first representation that changes values of the target metric according to different amounts spent on the marketing campaign of the first of the different types of channels.

5. The method of claim 1, wherein providing the second representation of the response of the target metric to time elapsed since the marketing campaign of a first of the different types of channels comprises providing the second representation that changes values of the target metric over the time elapsed since the marketing campaign of the first of the different types of channels.

6. The method of claim 1, wherein the second representation includes at least one or a combination of a representation of a time latency effect, a time smear effect, and a time decay effect.

7. The method of claim 1, wherein the target metric includes at least one selected from among revenue, profit, sales, return on investment, growth rate, and market share.

8. The method of claim 1, wherein providing the first representations and the second representations comprises solving for parameters of the first representations and the second representations by using the received values of the target metric, and the amounts spent.

9. The method of claim 8, wherein solving for the parameters comprises identifying values of the parameters for which a function has a minimum value, wherein the function includes the first representations and the second representations.

10. An article comprising at least one non-transitory machine-readable storage medium storing instructions that upon execution cause a system to:
receive input data including values of a target metric and amounts spent on respective different types of marketing channels;
derive spend response representations and time response representations for the respective different types of marketing channels, each of the spend response representations specifying a response of the target metric to an amount spent on a respective one of the different types of channels, and each of the time response representations specifying a time response to a marketing campaign of a respective one of the different types of channels,
wherein deriving the spend response models and the time response models is based on solving for parameters of the spend response representations and the time response representations using the input data; and
allocating a marketing budget across the different types of marketing channels using the derived spend response representations.

11. The article of claim 10, wherein solving for the parameters includes determining values of the parameters for which a function has a minimal value, the function including the spend response representations and the time response representations.

12. The article of claim 10, wherein solving for the parameters considers both the spend response representations and the time response representations simultaneously.

13. The article of claim 10, wherein the instructions upon execution cause the system to provide models of a response of the target metric to spend amounts for the respective different types of marketing channels, the models of the response of the target metric to spend amounts being based on the spend response representations.

14. The article of claim 10, wherein the time response representations include Gaussian functions.

15. A system comprising:
at least one processor to:
receive values of a target metric, and amounts spent on respective different types of channels for marketing an offering;
provide a first representation of a response of the target metric to an amount spent on a marketing campaign of each of the different types of channels;
provide a second representation of a response of the target metric to time elapsed since the marketing campaign of each of the different types of channels, the first representations and the second representations based on the received values of the target metric and the received amounts spent; and
determine models of a response of the target metric for the corresponding different types of channels, using the first representations and the second representations.
